(19) United States
(12) Patent Application Publication
(10) Pub. No.: US 2001/0031580 A1
(43) Pub. Date: Oct. 18, 2001

(54) Connector for smart cards

(75) Inventor: Fernando Romao, Montesson (FR)

Correspondence Address: BOYLE FREDRICKSON NEWHOLM STEIN & GRATZ S.C., SUITE 1030, 250 EAST WISCONSIN AVENUE, MILWAUKEE, WI, 53202, US

(73) Assignee: Sagem SA

(21) Appl. No.: 09/792,863

(22) Filed: Feb. 24, 2001

(30) Foreign Application Priority Data
Feb. 25, 2000 (FR) 00 02431

(51) Int. Cl. H01R 24/00

(52) U.S. Cl. 439/630

(57) ABSTRACT

To enable the insertion of an integrated circuit (8) between the contact terminals of a smart card (4) connecter (3) in a mobile telephone (1) and to simplify the manufacture of such a connector, an unoccupied location (7) is produced by making the connector out of two elements (5, 6), each supporting a group of flat contact terminals (3 1-3 3, 3 4-3 6) with contact surfaces (4 1-4 3, 4 4, 4 6) of the smart card.

### BACKGROUND OF THE INVENTION

1. Field of the Invention

An object of the present invention is a connector for smart cards. It can be applied therefore to the field of connection systems for smart cards. It can be applied especially to the field of connection systems for mobile telephones. The aim of the invention is to reduce the amount of space required by a smart card connector on a printed circuit receiving this connector. Thus, the useful surface on the printed circuit is increased. Furthermore, the cost of manufacturing a connector of this kind is reduced.

One of the main aims of mobile telephony is to achieve the maximum integration of the different means constituting a mobile telephone so that, ultimately, these means will require the minimum amount of space. However, certain elements are not integrated, most often because of the constraints that weigh upon them. In most cases, these constraints arise out of the application of standards. Thus, the contact terminals of connectors for smart cards are positioned in relation to each other according to the distances laid down by the standard. Indeed, this arrangement must provide for contact with all the contact regions of a smart card.

2. Description of the Prior Art

In the prior art, smart card connectors take the form of a single-piece block, generally provided with six elastic contact terminals to set up contact by pressure with a smart card, six terminals generally forming two rows of three terminals each.

This kind of a structure of smart card connectors raises problems. Indeed, the surface occupied by the connector on the printed circuit to which it is fixed generally takes up about 100 mm². Moreover, the cost of manufacturing the connector depends on the quantity of material used to manufacture it. In addition, the ratio between the surface of the printed circuit and the surface occupied by the electronic components on a printed circuit diminishes with the constant increase in the number of new functions to be integrated into the telephone.

It is an object of the invention to overcome these problems by proposing a connector with a smaller occupied surface area. For this purpose, the connector is made out of several elements. Thus, a part of the surface hitherto occupied by the one-piece connector is released. Consequently, the useful surface on the printed circuit is increased. This means in particular that this released surface can be used to position electronic components for example.

Furthermore, with the invention, the manufacture of a connector is simplified. Indeed, a prior art connector has two rows. The contact terminals on these two rows generally have the shape of elastic flat terminals. In most cases, two flat terminals that are in two different rows and face each other are placed in this connector symmetrically. In this case, to position the flat terminals, it is necessary either to use only one tool and make the connector pivot when the flat terminals of the second row have to be positioned or to use two tools, each responsible for placing the flat terminals in a row. With the invention, the same element is manufactured for both rows, thus calling for one and the same tool.

### SUMMARY OF THE INVENTION

The invention therefore relates to a smart card connector in a mobile telephone comprising a first row of contact terminals positioned in a first support and a second row of contact terminals positioned in a second support that is independent of the first support, the first support/row set and the second support/row set being identical and positioned in the mobile telephone so that the contact terminals are each in contact with a corresponding contact region of the smart card, wherein the connector comprises an unoccupied space between the first support and the second support, receiving an integrated circuit mounted on and connected to the printed circuit on which the supports are mounted and connected.

### BRIEF DESCRIPTION OF THE DRAWING

The invention will be understood more clearly from the following description and the appended figure. In this figure:

FIG. 1 shows a view of a connector according to the invention.

### MORE DETAILED DESCRIPTION

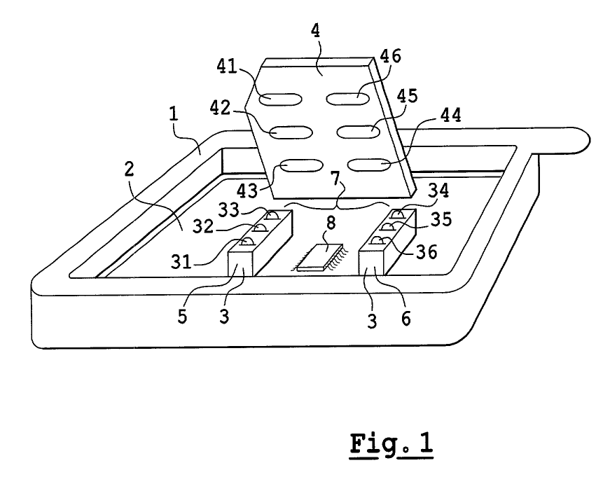

FIG. 1 shows a mobile telephone 1 whose supply battery has been removed to revisal a housing 2 in which a connector 3 according to the invention is placed. This connector 3 is used as an interface connector between the telephone 1 and a smart card 4. In general, the card 4 has contact surfaces. In the mobile telephone, the connector 3 has two rows of terminals or flat contact terminals 31 to 36. Each flat contact terminal provides an electrical contact, generally by pressure, with regions or surfaces 41 to 46 respectively of the card 4.

According to an essential characteristic of the invention, the connector 3 is made out of two independent elements 5 and 6. The element 5 has a first row of flat contact terminals, for example the flat contact terminals 31 to 33. The element 6 has a second row of flat contact terminals, for example the flat terminals 34 to 36. The element 5 is used as a first support 5 for the flat terminals 31 to 33 and the element 6 is used as a second support 6 for the flat terminals 34 to 36 respectively.

The support 5 and the support 6 are positioned in the housing 2 so that these flat terminals 31 to 36 are each in contact with a surface 41 to 46 respectively. Furthermore, the elements 5 and 6 are connected and even fixed to a printed circuit which is not shown, acting as their support. Thus, an unoccupied location 7 is obtained on the printed circuit between the two supports 5 and 6. This space 7 can be used especially for the positioning therein of an integrated circuit 8 or several integrated circuits. The number of integrated circuits that can be placed in the space 7 depends on the possibilities of integration as well as of reduction of this integrated circuit.

The support 5 is made in the invention in the same way as the support 6 in order that they may be identical. Thus, during the positioning of the supports 5 and 6 in the housing 2 of the telephone 1, there is no need to carry out controls pertaining to a position of a support 5 or 6 on the printed circuit. Furthermore, the supports 5 and 6 as well as the flat terminals 31 to 36 may be manufactured with the same materials as in the prior art.

What is claimed is:

1. A smart card connector in a mobile telephone comprising a first row of contact terminals positioned in a first support and a second row of contact terminals positioned in a second support that is independent of the first support, the first support/row set and the second support/row set being identical and positioned in the mobile telephone so that the contact terminals are each in contact with a corresponding contact region of the smart card, wherein the connector comprises an unoccupied space between the first support and the second support, receiving an integrated circuit mounted on and connected to the printed circuit on which the supports are mounted and connected.
